(19) United States
(12) Patent Application Publication
(10) Pub. No.: US 2005/0216215 A1
(43) Pub. Date: Sep. 29, 2005

(54) TIMER SYSTEM AND METHOD CAPABLE OF DYNAMICALLY COMPENSATING A DIFFERENCE BETWEEN A COUNT VALUE AND A THRESHOLD VALUE FOR THE IMPRECISION OF A TIMER

(76) Inventor: Wei-Guan YAU, Hsin-Chu Hsien (TW)

Correspondence Address: NORTH AMERICA INTERNATIONAL PATENT OFFICE (NAIPC), P.O. BOX 506, MERRIFIELD, VA, 22116, US

(21) Appl. No.: 10/708,799

(22) Filed: Mar. 26, 2004

(51) Int. Cl. G06F 15/00

(52) U.S. Cl. 702/79

(57) ABSTRACT

A timer system and a method capable of compensating a difference between a count value and a threshold value for the imprecision of a timer. The timer system includes a timer for repeatedly triggering a reference event according to a predetermined time interval; a first storage unit storing a threshold value; a second storage unit storing a count value corresponding to the triggered reference events; a tracking module tracking an actual time interval between a first reference event and a second reference event; a calculating module calculating a compensation value; a compensating module for reducing a difference between the count value and the threshold value; and a decision logic for generating the acknowledgement event if the count value is no longer less than the threshold value.

### BACKGROUND OF INVENTION

1. Field of the Invention

The invention relates to a method and a device for tuning a timer system having an unstable timer, and more particularly, to a method and a timer system capable of dynamically compensating for a difference between a count value and a threshold value for the imprecision of a timer.

2. Description of the Prior Art

Timer systems are important in electronic devices for scheduling and managing the various operations within the electronic device. Timer systems usually function by tracking time and issuing an alarm when a specified amount of time has passed.

The implementation of a timer system can be divided into two categories: software-based and hardware-based. Software-based timer systems employ the use of a microprocessor of an electronic device for running a software timer program (e.g. firmware of the electronic device) to poll a hardware timer installed in the electronic device. The hardware timer then outputs interrupts to notify the microprocessor when a specified amount of time has passed. However, it is not only difficult to write the appropriate code to carry out the function, but this solution also takes away from system resources that could be used for other purposes. Hardware-based timer systems, however, use separate hardware parts to carry out the function of the software timer program. In this way, the complexity of writing the code for software-based timers can be avoided, and more system resources can be devoted to other tasks.

In most cases, a timer system comprises a timer coupled to a clock source, a counter, a comparator, and a storage device containing a threshold value. The timer generates an event each time a specified amount of time passes. The clock source outputs a clock signal to drive the timer, and the timer is capable of tracking how much time has passed according to the clock signal. The counter is coupled to the timer and counts each time the timer generates an event. The comparator serves to compare the count value with the threshold value of the storage device. The threshold value stored in the storage device serves to indicate how much time should be passed before the timer system issues an alarm. Therefore, when the threshold value and the count value are equal, the timer system issues an alarm.

The timer systems do, however, suffer from a major disadvantage. The clock sources of most timers are unstable. The instability of the clock source means that the timer will not always be able to generate an event on time, which means that the timer system will be slow in issuing an alarm. For example, suppose that it is desired that the timer system issue an alarm after 200 ms has passed and that the timer is set to generate an event for every 20 ms. Given these conditions, 10 events should be generated in order to reach 200 ms; therefore, the threshold value should be set to 10. Ideally, that means when the timer generates tenth event, the count value will match the threshold, which causes the timing system to issue an alarm after 200 ms has passed.

However, as previously mentioned, the clock source is unstable. This means that it could actually take more than 20 ms before the timer generates an event. Taking the above situation, suppose the timer takes 40 ms instead of the set 20 ms to generate an event. This means that when the count value reaches 10, therefore matching the threshold value and causing the timing system to issue an alarm, 400 ms will actually have passed instead of the desired 200 ms.

One prior art solution employs a static method for compensating the counter in the event that the timer does not generate an event according to a specified time. For example, take the above situation where the timer takes 40 ms instead of the set 20 ms value to generate an event. Under the prior art solution, the timer system will examine whether or not the first event took the set 20 ms to generate an event. If it takes 20 ms, nothing is done. If it takes longer, then the timer system will create a compensation value to be used to increment the counter. Obviously, in this case, 40 ms is not equal to 20 ms. Since the counter is incremented by 1 because every generated event should take 20 ms, the compensation value for 40 ms is 2. The counter will then be incremented using this static compensation value of 2 from this generated event and every generated event afterwards. As one can see, by doing so, the counter will reach the threshold value after only 5 events have been generated. In this way, the timer system is able to issue an alarm at 200 ms.

However, the prior art solution has a drawback of its own in that the prior art solution assumes that the instability of the clock source is constant. In other words, if the prior art solution finds that the first event generated by the timer takes 40 ms instead of the set 20 ms, the prior art solution then assumes that all generated events will take 40 ms. When the instability of the clock source is unstable, then the flaws of the prior art solution can be clearly seen. For example, suppose that the timer takes 40 ms to generate the first event, 60 ms to generate the second event, 80 ms to generate the third event, and 20 ms for the rest of the events. Under the prior art solution, the timer system will determine, from the first event taking 40 ms, that a compensation value of 2 should be added to the counter each time an event is generated. That means the count value will reach the threshold value of 10 after 5 events. However, after 5 events, 220 ms will have passed instead of the desired 200 ms. The count value should have been reached the threshold value after 4 events, but because of the static nature in the calculation of a compensation value in the prior art solution, the timer system under the prior art cannot achieve this result.

### SUMMARY OF INVENTION

It is therefore one of the many objectives of the claimed invention to provide a method and a timer system capable of dynamically compensating for a difference between a count value and a threshold value for the imprecision of a timer to solve the above-mentioned problem.

According to the claimed invention, a timer system embedded in an electronic device able to dynamically compensate a counting mechanism for the imprecision of its timer is disclosed. The timer system comprises a timer for repeatedly triggering a reference event according to a predetermined time interval; a first storage unit for storing a threshold value; a second storage unit for storing a count value corresponding to a plurality of reference events generated from the timer; a tracking module electrically connected to the timer for tracking an actual time interval between a first reference event and a second reference event occurring after the first reference event; a calculating module electrically connected to the tracking module for calculating a compensation value from the predetermined time interval and the actual time interval; a compensating module electrically connected to the calculating module and at least one of the first and second storage units for reducing a difference between the count value and the threshold value; and a decision logic electrically connected to the first and second storage units for generating the acknowledgement event if the count value is no longer less than the threshold value.

Also according to the claimed invention, a method related to dynamically compensating a counting mechanism for the imprecision of a timer in a timer system embedded in an electronic device is disclosed. The method comprises storing a threshold value; storing a count value corresponding to a plurality of reference events generated from the timer; tracking an actual time interval between a first reference event and a second reference event occurring after the first reference event; calculating a compensation value from the predetermined time interval and the actual time interval; utilizing the compensation value for reducing a difference between the count value and the threshold value; and generating the acknowledgement event if the count value matches the threshold value.

One of the many advantages provided by the claimed invention is the ability to have the compensation value change dynamically in response to fluctuations in the timing from generated event to generated event instead of the static compensation value employed by the prior art. As a result of this dynamic compensation value, the claimed invention can serve as a more accurate timing system and issue an acknowledgement closer to the desired time than the prior art.

These and other objectives of the claimed invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a block diagram of a timer system according to the present invention.

FIG. 2 is a flow chart of a method employed by the timer system shown in FIG. 1.

FIG. 3 is another flow chart of a method employed by the timer system shown in FIG. 1.

### DETAILED DESCRIPTION

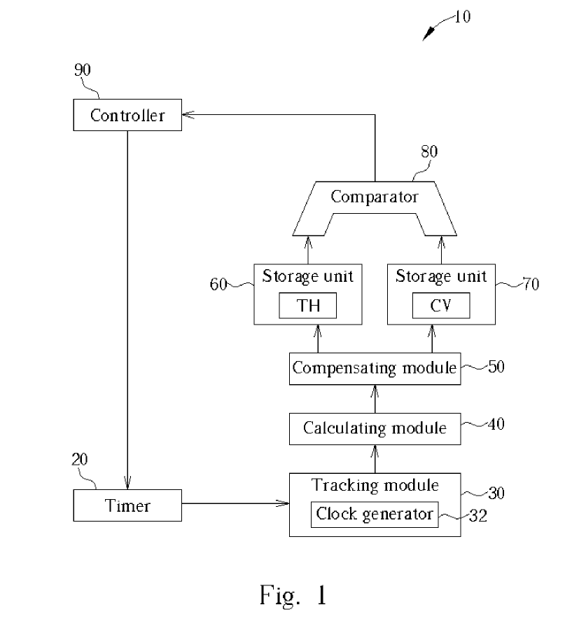

Please refer to FIG. 1. FIG. 1 is a block diagram of a timer system 10 according to the present invention. In this preferred embodiment, the timer system 10 comprises a timer 20, a tracking module as embodied by a reference clock 30, a calculating module 40, a compensating module 50, a first storage unit 60 storing a threshold value, a second storage unit 70 storing a counter value, a decision logic as embodied by a comparator 80, and a microprocessor 90. In addition, the tracking module 30 comprises a clock generator 32 for serving as a reference clock used to accurately track an actual time interval between every two adjacent events triggered by the timer 20. However, the clock generator 32 cannot issue an interrupt; therefore it can only be used for serving as a reference clock and cannot replace the timer function. As mentioned before, the timer system 10 can be implemented as a software-based timer system or a hardware-based timer system. Concerning the hardware-based timer system, the elements within the timer system 10 are separate hardware devices. However, for the software-based timer system, a microprocessor with logic gates implementing the controller 90, the calculating module 40, the compensating module 50, the storage units 60, 70, and the comparator 80 are utilized to run the software timer program correctly. In other words, the controller 90, the calculating module 40, the compensating module 50, the storage units 60, 70, and the comparator 80 can be positioned with the microprocessor for running the software timer program to trigger a notification, and the controller 90, the calculating module 40, the compensating module 50, the storage units 60, 70, and the comparator 80 can also be pure hardware devices to trigger the notification without running the software timer program.

The timer 20 serves to continually generate an event (e.g. a system interrupt) after a predetermined time value. The tracking module 30 is electrically coupled to timer 20 to track the amount of time that passes between two events known from here forth as an actual time interval value. The calculating module 40 is electrically coupled to the tracking module 30 and serves to calculate a compensation value from the predetermined time value and the actual time interval value. The compensating module 50 is coupled to the calculating module 40 and at least one of the two storage units 60, 70 and serves to decrease the difference between the count value CV and the threshold value TH. The storage unit 60 stores the threshold value TH, which represents the desired number of events wished to be passed, and the storage unit 70 stores the count value CV, which is for tracking the appropriate amount of generated events that should have been passed. The decision logic as embodied by the comparator 80 is for determining if the count value reaches the threshold value, and if it does, then generating an acknowledgement signal. In the preferred embodiment, the controller 90 drives the timer 20 by an unstable driving clock and receives the acknowledgement signal sent from the comparator 80. Because the driving clock is unstable, the characteristic of timer 20 becomes unstable. Please note that the above given description is simply an example of an embodiment and is not intended to be taken as a limitation of the claimed invention.

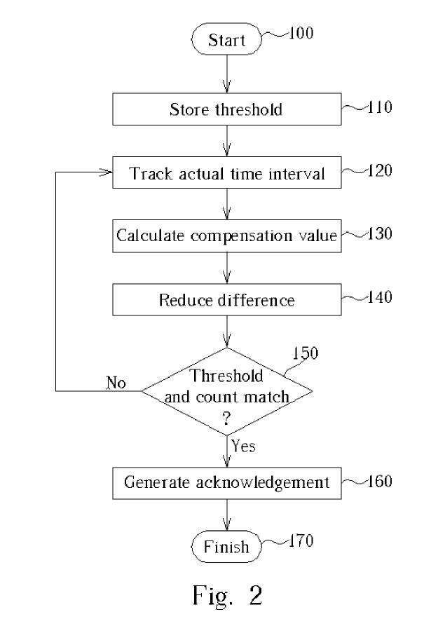

Please refer to FIG. 2. FIG. 2 is a flow chart of a method employed by the timer system 10 shown in FIG. 1. The method for dynamically compensating a counting mechanism for the imprecision of the timer 20 comprises the following steps:

Step 100: Start

Step 110: Store Threshold. The timer system 10 stores a threshold value TH into the storage unit 60. This threshold value TH serves as the control for how much time is allowed to pass before the comparator 80 generates the acknowledgement signal to the microprocessor 90.

Step 120: Track Actual Time Interval. Based on the unstable driving clock, the timer 20 continually generates an event each time a predetermined amount of time has passed. When a first event is generated by the timer 20, the tracking module 30 will begin utilizing the accurate reference clock outputted from the clock generator 32 to count the time until a second event is generated by the timer 20 in order to calculate an actual time interval value.

Step 130: Calculate Compensation Value. Using the actual time interval value and the predetermined value, the calculating module 40 determines an appropriate compensation value to adjust the count value or/and threshold value.

Step 140: Reduce Difference. Using the compensation value determined from the calculating module 40, the compensating module 50 reduces the difference in value between the threshold value TH and the count value CV.

Step 150: Threshold and Count Match? The comparator 80 checks if the count value CV of the storage unit 70 reaches the threshold value TH of the storage unit 60. If the count value CV does not reach the threshold value TH yet, return to Step 120. If the count value reaches the threshold value, go to Step 160.

Step 160: Generate Acknowledgement. With the count value CV reaching the threshold value, the amount of desired time has passed. As a result, the comparator generates an acknowledgement signal to the microprocessor 90.

Step 170: Finish

Please refer to both FIG. 1 and FIG. 2. In Step 110, a threshold value TH is stored by the timer system 10 into the storage unit 60. This threshold value TH serves as a control for generating the acknowledgement signal of the timer system 10. In Step 120, as the timer 20 generates events according to a predetermined amount of time, the tracking module 30 will begin utilizing the accurate reference clock outputted from the clock generator 32 to count the amount of time that passes between two consecutively generated events. In other words, synchronization of the timer 20 and clock generator 30 will reveal the actual elapsed time of the two adjacent reference events and therefore the tracking of the actual time interval can be achieved.

This actual time interval value is used in Step 130 by the calculating module 40 to generate a compensation value. In this preferred embodiment, the compensation value is the ratio of the actual time interval value to the predetermined value that the timer 20 generates events according to a users setting. The value of the ratio used in this preferred embodiment is a closest integer value of the ratio. For example, if the ratio were 5:2, then 3 instead of 2 would be used as the ratio value. On the contrary, if the ratio were 10:3, then 3 instead of 4 would be used as the ratio value. Please note that other embodiments of the invention may choose to use floating point notation for representing numbers. In this case, the closest integer value of the ratio will not be used as the value of the ratio; instead the decimal notation of the ratio will be used, the accuracy dependent on the user's selection. For example, if the ratio again were 5:2, then 2.5 would be used as the ratio value. In either case, the claimed invention should not be limited to either integer or floating point notation as the two serve merely as example embodiments.

Then in Step 140, the compensating module 50 uses the compensation value to reduce the difference in value between the threshold value TH of the storage unit 60 and the count value CV of the storage unit 70. In this preferred embodiment, the compensating module 50 simply adds the compensation value to the counting value. For example, if the compensation value were 3, then the count value would be increased by three. Please note that this is only an example embodiment. Other embodiments may choose to divide the compensation value between the count value and the threshold value or alter only the threshold value. For example, if the compensation value were 3, another embodiment of the claimed invention could choose to increase the count value CV by 2 and decrease the threshold value TH by 1, and still yet, another embodiment of the claimed invention could choose to only decrease the threshold value TH by 3. In any case, all three ways are equivalent and covered by the claimed invention. Please note that these three ways are merely examples and do not limit the claimed invention.

After reducing the difference in Step 140, the comparator 80 of the timer system 10 checks if the count value reaches the threshold in step 150. If the count value does not reach the threshold yet, then the desired amount of time wished to be passed has not been reached, and the timer system 10 returns to Step 120 to further reduce the difference between the count value CV and the threshold value TH. However, if the count value CV reaches the threshold value TH, then the desired amount of time wished to be passed has been reached. As a result, the comparator 80 issues an acknowledgement signal to notify the controller 90. Then, the controller 90 can enable a certain action after receiving the acknowledgement signal.

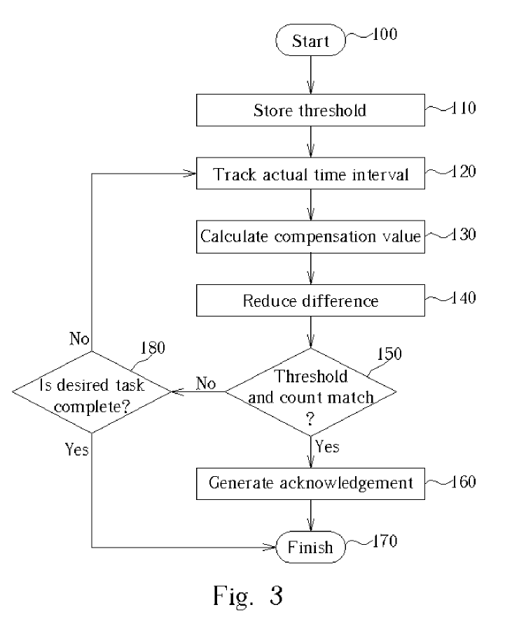

Please refer to FIG. 3 in conjunction with FIG. 2. FIG. 3 is another flow chart of a method employed by the timer system 10 shown in FIG. 1. A major difference between the flows shown in FIG. 2 and FIG. 3 is that an additional step 180 is added to the flow shown in FIG. 3. It is clear that the flow shown in FIG. 2 is merely a tracking mechanism used for tracking a predetermined period of time. That is, when the predetermined period of time has passed, the flow shown in FIG. 2 is sure to trigger an acknowledgement. However, in addition to tracking the predetermined period of time, the method according to the present invention also can make use of the tracking mechanism to time the execution of a desired task. For instance, an optical disk drive is required to recognize a disk type (ex. CD-R or CD-RW) of an optical disk within a predetermined period of time when the optical disk is loaded into the optical disk drive. When the optical disk is loaded into the optical disk drive, the flow shown in FIG. 3 is started (step 100). Based on the predetermined period of time, the threshold value TH is set accordingly (step 120). Please note that detailed operations of these steps 110, 120, 130, 140, 150, and 160 have been clearly described before. As a result, the same lengthy description is not repeated for simplicity.

As shown in FIG. 3, if the count value CV does not reach the threshold value TH, the fulfillment of the desired task is checked (step 180). The flow shown in FIG. 3 is terminated if the desired task has been completed (step 170) even if the count value CV has not reached the threshold value TH yet. In other words, the optical disk drive has recognized the disk type of the loaded optical disk within the predetermined period of time, meaning that there is no need to time the execution of the desired task. On the other hand, if the optical disk drive is unable to recognize the disk type of the loaded optical disk in time, that is, the count value CV has reached the threshold value TH, an acknowledgement event is generated (step 160) to indicate a fail status. To sum up, the method according to the present invention not only triggers an acknowledgement event by tracking a predetermined period of time but also is capable of monitoring the execution of a desired task with the help of the tracking mechanism.

To illustrate more clearly, take the timer system given in the prior art example, where the timer is supposed to generate an event at a predetermined value of 20 ms (therefore having a threshold value of 10 to reach 200 ms) but takes 40 ms to generate the first event, 60 ms to generate the second event, 80 ms to generate the third event, and 20 ms for the rest of the events. Remember that because of the static nature of the prior art solution, which uses a constant compensation value of 2, the prior art timer system reaches the threshold value in 5 events, which equates to 220 ms.

Now, under the claimed invention, the timer system 10 will reach the threshold in 4 events, which equates to 200 ms the exact amount of desired time. Suppose that an initial value of the count value CV is equal to 0. Please note that the initial value of the threshold value TH is set to 10. When the timer 20 is started, the tracking module 30 is reset to start counting. After 40 ms, the timer 20 triggers the first event. The calculating module 40 determines the compensation value to be 2 because the ratio between the actual time interval value 40 ms and the predetermined value 20 ms is 2. The compensating module 50 then adds this to the count value, making the count value CV equal 2. Because the count value CV is less than the threshold value TH, the timer system 10 goes back to Step 120. Second time through, the actual time interval value is 60 ms this time. As a result, the calculating module 40 determines the compensation value to be 3 because the ratio between the actual time interval value 60 ms and the predetermined value 20 ms is 3. The count value therefore becomes 5 after the reducing Step 140. In Step 150, the count value CV is still found to be less than the threshold value TH, and once again, the timer system 10 returns to Step 120. Third time through, the actual time interval is 80 ms. As a result, the compensation value is 4. After the reducing step 140, the count value CV becomes 9. The count value is still less than the threshold value TH, and the timer system 10 returns to Step 120. Fourth time through, the actual time interval is 20 ms. The compensation value therefore is 1. After adding the compensation value, the count value CV becomes 10, which means that the count value CV reaches the threshold value TH. As a result, the comparator 80 generates an acknowledgement signal to notify the controller 90. In this way of dynamically adjusting a difference between the count value CV and the threshold value TH for the imprecision of the unstable timer 20, the timer system 10 is able to generate an acknowledgment signal in 4 events, which equates to 200 ms.

As described above, the initial value of the threshold value TH is designed to be greater than the initial value of the count value CV. Therefore, when the difference between the count value CV and the threshold value TH is reduced by the compensation value M, the count value CV is increased by the compensation value M, the threshold value TH is decreased by the compensation value M, or the count value CV is increased by a value N extracted from the compensation value M, the threshold value TH is decreased by another value M-N extracted from the compensation value M. However, the initial value of the count value CV can be designed to be greater than the initial value of the threshold value. Therefore, when the difference between the count value CV and the threshold value TH is reduced by the compensation value M, the count value CV is decreased by the compensation value M, the threshold value TH is added by the compensation value M, or the count value CV is decreased by a value N extracted from the compensation value M, the threshold value TH is added by another value M-N extracted from the compensation value M. The same objective of tracking the time passed is achieved.

Please note in some cases, the timer system may pass more time than the exact time desired. This is because the actual time interval value will not always be perfectly divisible by the predetermined value. In this case, if one wishes to further improve the accuracy of the timer system 10, the predetermined value can simply be decreased. In this case, we can decrease it from 20 ms to 10 ms. Remember that the threshold value TH must be adjusted accordingly if such changes are made. When the predetermined value is properly cut down, a round-off error corresponding to the remainder is reduced accordingly. For example, if the predetermined value is set to 20 ms, the maximum round-off error is equal to 10 ms. However, if the predetermined value is set to 10 ms, the maximum round-off error becomes 5 ms only. In other words, the impact of the accumulated round-off errors on the tracking of time is alleviated with a reduced predetermined value of the timer 20.

Please note that using the count value CV of the storage unit 70 to count events is only one embodiment and should not be taken as a limitation. In other embodiments, the count value CV could very well track the actual amount of time. For instance, in the above example, instead of storing a value of 2 when the actual time interval is 40 ms into the count value, the timer system 10 could store 40. In this case, we no longer count events, which represent a certain amount of time, but we count the time itself. If this embodiment is chosen, then a calculating module 40 is no longer needed and the threshold value TH is given a value to represent the total time and not events. In summary, take for example a timer system like the one in the above situation, where the timer is supposed to generate an event at a predetermined value of 20 ms but takes 40 ms to generate the first event, 60 ms to generate the second event, 80 ms to generate the third event, and 20 ms for the rest of the events (a threshold value has a value of 10 because the predetermined value is 20 ms but since we no longer count events the threshold value is set to 200 to represent the 200 ms we wish to pass). After the first event, the counter is increased by 40, not by 2 like when events were counted. After the second event, the counter is increased by 60, not by 3 like when events were counted. After the third event, the counter is increased by 80, not by 4 like when events were counted. Finally, after the fourth event, the counter is increased by 20, not by 1 like when events were counted. The end result is the counter obtains a value of 200 after 4 events, which is equal to the threshold value of 200. Therefore, the timer system will issue an acknowledgement signal after 4 events, which is equal to 200 ms. The advantage of this method is it has no round-off error since it is directly accumulating the actual time and not the closest integer value of the number of events.

Please note that counting events or counting time are merely example embodiments of the claimed invention. They should not be taken as limitations of the claimed invention.

As one can see, one of the benefits of the claimed invention is an improvement in the accuracy of a timer system. By dynamically adjusting the difference between a count value and a threshold value for the imprecision of an unstable timer in a timer system, the amount of time passed is closer to the desired amount. To sum up, the performance of the timer system is greatly improved.

Those skilled in the art will readily observe that numerous modifications and alterations of the device may be made while retaining the teachings of the invention. Accordingly, that above disclosure should be construed as limited only by the metes and bounds of the appended claims.

1. A method for dynamically compensating for the imprecision of a timer, the timer repeatedly triggering a reference event according to a predetermined time interval, the method comprising the steps of:
storing a threshold value;
storing a count value corresponding to a plurality of reference events generated from the timer;
tracking an actual time interval between a first reference event and a second reference event occurring after the first reference event;
calculating a compensation value from the predetermined time interval and the actual time interval; and
utilizing the compensation value for reducing a difference between the count value and the threshold value.

2. The method of claim 1 further comprising generating an acknowledgement event if the count value reaches the threshold value.

3. The method of claim 1 wherein the step of tracking the actual time interval further comprises tracking an actual time interval between every two adjacent reference events.

4. The method of claim 3 wherein the step of tracking the actual time interval further comprises utilizing a reference clock for computing a time value corresponding to the actual time interval between every two adjacent reference events, and resetting the time value before the reference clock starts tracking the actual time interval between the first reference event and the second reference event.

5. The method of claim 1 wherein the step of calculating the compensation value further comprises determining the compensation value by calculating a ratio of the actual time interval to the predetermined time interval.

6. The method of claim 5 wherein the step of calculating the compensation value further comprises utilizing an integer closest to the ratio to be the compensation value.

7. The method of claim 5 wherein the compensation value is a floating point value, and records the ratio of the actual time interval to the predetermined time interval.

8. The method of claim 1 wherein an initial value of the threshold value is greater than an initial value of the count value, and the step of utilizing the compensation value for reducing the difference further comprises increasing the count value and reducing the threshold value for reducing the difference by the compensation value.

9. The method of claim 1 wherein an initial value of the threshold value is greater than an initial value of the count value, and the step of utilizing the compensation value for reducing the difference further comprises adding the compensation value to the count value without adjusting the threshold value for reducing the difference by the compensation value.

10. The method of claim 1 wherein an initial value of the threshold value is less than an initial value of the count value, and the step of utilizing the compensation value for reducing the difference further comprises decreasing the count value and increasing the threshold value for reducing the difference by the compensation value.

11. The method of claim 1 wherein an initial value of the threshold value is less than an initial value of the count value, and the step of utilizing the compensation value for reducing the difference further comprises subtracting the compensation value from the count value without adjusting the threshold value for reducing the difference by the compensation value.

12. The method of claim 1 wherein the reference events are system interrupts.

13. A method for dynamically compensating for the imprecision of a timer, the timer repeatedly triggering a reference event, the method comprising the steps of:
storing a threshold value and a count value;
tracking an actual time interval between every two reference events; and
updating the count value by a value calculated through accumulating a plurality of actual time intervals corresponding to a plurality of reference events.

14. The method of claim 13 further comprising generating an acknowledgement event if the count value reaches the threshold value.

15. The method of claim 13 wherein the step of tracking the actual time interval further comprises tracking the actual time interval between every two adjacent reference events.

16. The method of claim 15 wherein the step of tracking the actual time interval further comprises utilizing a reference clock for computing a time value corresponding to the actual time interval between every two adjacent reference events, and resetting the time value before the reference clock starts tracking the actual time interval between a first reference event and a second reference event.

17. The method of claim 13 wherein the reference events are system interrupts.

18. A timer system comprising:
a timer for repeatedly triggering a reference event according to a predetermined time interval;
a first storage unit for storing a threshold value;
a second storage unit for storing a count value corresponding to a plurality of reference events generated from the timer;
a tracking module electrically connected to the timer for tracking an actual time interval between a first reference event and a second reference event occurring after the first reference event;
a calculating module electrically connected to the tracking module for calculating a compensation value from the predetermined time interval and the actual time interval; and
a compensating module electrically connected to the calculating module and at least one of the first and second storage units for reducing a difference between the count value and the threshold value.

19. The timer system of claim 18 further comprising a decision logic electrically connected to the first and second storage units for generating an acknowledgement event if the count value reaches the threshold value.

20. The timer system of claim 18 wherein the first and second storage units, the counting module, the calculating module, compensating module, and the decision logic are positioned within a microprocessor, and the timer is driven by the microprocessor.

21. The timer system of claim 18 wherein the tracking module comprises a clock generator for serving as a reference clock, and the tracking module utilizes the reference clock for computing a time value corresponding to the actual time interval between every two adjacent reference events, and resets the time value before the reference clock starts tracking the actual time interval between the first reference event and the second reference event.

22. The timer system of claim 18 wherein the compensating module determines the compensation value by calculating a ratio of the actual time interval to the predetermined time interval.

23. The timer system of claim 22 wherein the compensating module utilizes an integer closest to the ratio to be the compensation value.

24. The timer system of claim 22 wherein the compensating module utilizes a floating point value to be the compensation value for recording the ratio of the actual time interval to the predetermined time interval.

25. The timer system of claim 18 wherein an initial value of the threshold value is greater than an initial value of the count value, and the compensating module increases the count value and reduces the threshold value for reducing the difference by the compensation value.

26. The timer system of claim 18 wherein an initial value of the threshold value is greater than an initial value of the count value, and the compensating module adds the compensation value to the count value without adjusting the threshold value for reducing the difference by the compensation value.

27. The timer system of claim 18 wherein an initial value of the threshold value is less than an initial value of the count value, and the compensating module decreases the count value and increases the threshold value for reducing the difference by the compensation value.

28. The timer system of claim 18 wherein an initial value of the threshold value is less than an initial value of the count value, and the compensating module subtracts the compensation value from the count value without adjusting the threshold value for reducing the difference by the compensation value.

29. The timer system of claim 18 wherein the reference events are system interrupts of the timer system.

30. A timer system comprising:
a timer for repeatedly triggering a reference event;
a first storage unit for storing a threshold value;
a second storage unit for storing a count value;
a tracking module electrically connected to the timer for tracking an actual time interval between every two reference events; and
a calculating module electrically connected to the tracking module for updating the count value by a value calculated through accumulating a plurality of actual time intervals corresponding to a plurality of reference events.

31. The timer system of claim 30 further comprising: a decision logic electrically connected to the first and second storage units for generating an acknowledgement event if the count value reaches the threshold value.

32. The timer system of claim 30 wherein the first storage unit, the second storage unit, the calculating module, and the decision logic are positioned within a microprocessor, and the timer is driven by the microprocessor.

33. The timer system of claim 30 wherein the tracking module comprises a clock generator for generating a reference clock, and the tracking module utilizes the reference clock for computing a time value corresponding to the actual time interval between every two adjacent reference events, and resets the time value before the reference clock starts tracking an actual time interval between a first reference event and a second reference event.

34. The timer system of claim 30 wherein the reference events are system interrupts of the timer system.
